(19) United States
(12) Patent Application Publication
(10) Pub. No.: US 2024/0268244 A1
(43) Pub. Date: Aug. 15, 2024

(54) Agricultural Implement Tool for Undesired Plant Removal

(71) Applicant: Greentech Robotics Limited, Palmerston North (NZ)

(72) Inventor: Donald H. Sandbrook, Palmerston North (NZ)

(21) Appl. No.: 18/167,376

(22) Filed: Feb. 10, 2023

(51) Int. Cl. A01B 39/18; A01B 35/28

(52) U.S. Cl. CPC A01B 39/18; A01B 35/28

(57) ABSTRACT

Rotatable plant removal devices and methods of use are disclosed herein. An example device a tubular sleeve, a shaft extending through the tubular sleeve, a material removal tool that is positioned between a terminal end of the shaft and an end of the tubular sleeve, and a mounting member that is rotatably coupled to the shaft. The mounting member allows the material removal tool and the shaft to freely rotate as the device is propelled in a direction of travel within soil. The material removal tool and the shaft freely rotate to prevent collection of material around the device.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

The described example embodiments in general relate to agricultural devices for removal of unwanted plants (e.g., weeds).

Agricultural cropping operations often result in the growth of undesired plants, either in the form of weeds or over-planted crops that are then thinned to the desired spacing after germination. For these cropping operations to be successful, the undesired plants are removed with minimal disruption to the soil and desired plants. Minimal soil disturbance is essential as dormant weed seeds in the soil can be agitated which may result in the germination of the weeds, exacerbating the problem.

Existing mechanical weeding implement tools, on tractor implements or autonomous agricultural robots, are typically rigidly mounted directly to the implement or an actuator. This rigid mounting is required to accurately control the path of the tool. For minimal soil disturbance, as the tool typically operates just below the soil surface, the rigid mounting typically has a low profile in the forward-facing direction.

These existing designs have drawbacks such as unwanted organic matter (or other items), referred to as “trash,” building up around the rigid mount (such as a shaft) of the implement tool. This build-up often forms a significant bulldozer-type effect before clearing, if clearing at all. The build-up of unwanted materials around the device can then become a barrier. For example, the accumulation of unwanted material around the device impairs the ability of the device to be placed near plants as well as reduces the ability of the tool to create minimal soil disturbance.

### SUMMARY

In one embodiment, the present disclosure pertains to a device comprising a tubular sleeve, a shaft extending through the tubular sleeve, a material removal tool that is positioned between a terminal end of the shaft and an end of the tubular sleeve, and a mounting member that is rotatably coupled to the shaft. In some embodiments, the mounting member allows the material removal tool and the shaft to freely rotate as the device is propelled in a direction of travel within the soil. The material removal tool and the shaft freely rotate to prevent the collection of material around the device as it is used.

In one embodiment, the present disclosure pertains to a device comprising a shaft, a material removal tool that is coupled to a terminal end of the shaft, and a mounting member rotatably coupled to the shaft. The mounting member is configured to couple with a driving implement, and the material removal tool and the shaft freely rotate to prevent the collection of material around the shaft or the material removal tool during use. In one or more embodiments, the material removal tool has a polygonal shape with arcuate vertices that encourage rotation of the material removal tool when the material removal tool contacts material while being propelled in a direction of travel.

In one embodiment, the present disclosure pertains to a device comprising a sleeve having a first end and a second end, a shaft extending at least partially through the sleeve, the shaft having a first end and a second end, a material removal tool coupled to the first end of the shaft, the material removal tool being located between the first end of the shaft and the first end of the sleeve, the material removal tool having a serrated or beveled edge, a first securement member coupled to the shaft and positioned above the second end of the sleeve, a mounting member located above the first securement member, the mounting member being rotatably coupled to the shaft allowing the shaft and the material removal tool to freely rotate, and a second securement member coupled to the shaft above the mounting member.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting. To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is a perspective view of an example driving implement in combination with an example plant removal device in accordance with an example embodiment.

FIG. 2 is a cross-section view of an example plant removal device of the present disclosure.

FIGS. 3A and 3B collectively illustrate the rotation of an example material removal tool of a plant removal device in operation, removing a weed from soil.

FIG. 4 is a schematic diagram of architecture where aspects of the present disclosure can be practiced.

FIG. 5 is a cross-sectional view of another example plant removal device.

FIGS. 6 and 7 each illustrate example material removal tools, each having a different geometry.

### DETAILED DESCRIPTION

### A. Overview.

Some of the various embodiments of the present disclosure relate to rotatable tools which are configured to remove unwanted materials, such as weeds or other organic materials from soil, without accumulating material around the tools. An example rotatable tool can be mounted to a driving implement such as a tractor or an autonomous robot.

One example embodiment includes a material removal tool, such as a blade, which is mounted to a shaft. The shaft can be coupled to the driving implement with a mounting member. In some instances, the shaft freely rotates relative to the mounting member and the mounting member can be fixedly secured to a portion of the driving implement. When the material removal tool (and a portion of the shaft in some instances) is brought into contact with the soil and translated in a direction of travel, the shape of the material removal tool causes the material removal tool to rotate due when it contacts the soil or objects in the soil. Rotation of the material removal tool dislodges unwanted objects such as weeds from the soil and ensures that materials diverge around the device.

In various embodiments, the material removal tool has a polygonal shape, such as a triangle. The vertices of the polygon can be rounded (arcuate in shape) reduce a likelihood of materials getting hung up on parts of the device. In some embodiments, the material removal tool has an outer-peripheral geometry that encourages rotation of the material removal tool as it is moved through the soil. In some embodiments, the edge of the tool can be beveled or serrated to enhance the cutting ability of the tool. In some instances, the material removal tool can be rotated by a motor or other similar actuator.

In some instances, the shaft is covered, at least partially, with a sleeve. The sleeve protects the shaft from contact with soil or organic material. The sleeve is also free to rotate to prevent unwanted materials from accumulating around the sleeve. The mounting member can include a body that surrounds the shaft (or sleeve in some embodiments). The body incorporates bearings or other similar rotational elements that allow for free rotation of the shaft and material removal tool. The mounting member can be fixed relative to the driving implement or maybe on the end of an actuator arm that can raise and lower the tool, either on a tractor-based implement or an autonomous robot.

### B. Example Embodiments

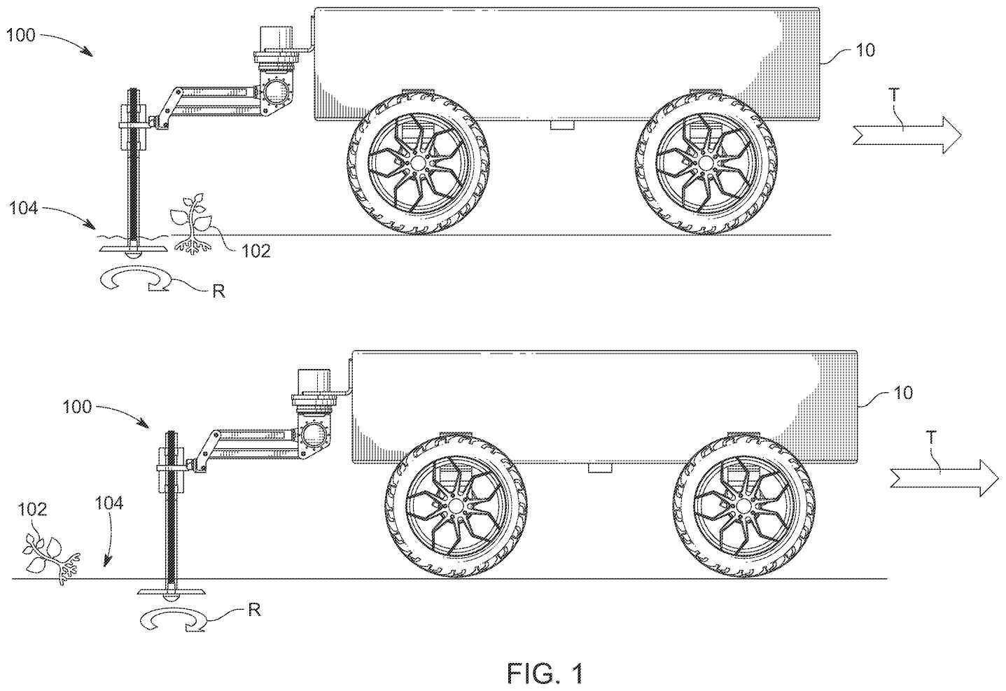

FIG. 1 is a perspective view of an example driving implement 10 in combination with an example plant removal device (hereinafter “device 100”). Collectively, this system can be used to remove unwanted material, such as a weed 102 from soil 104 or another similar substrate. The device 100 is rotatably mounted to the driving implement 10 in such a way that as the driving implement 10 moves in a direction of travel 105, the device 100 is translated through the soil 104 to till the soil and remove unwanted material such as rocks, weeds, or other unwanted materials. The tilling or removing of material occurs as the device 100 freely rotates during translation.

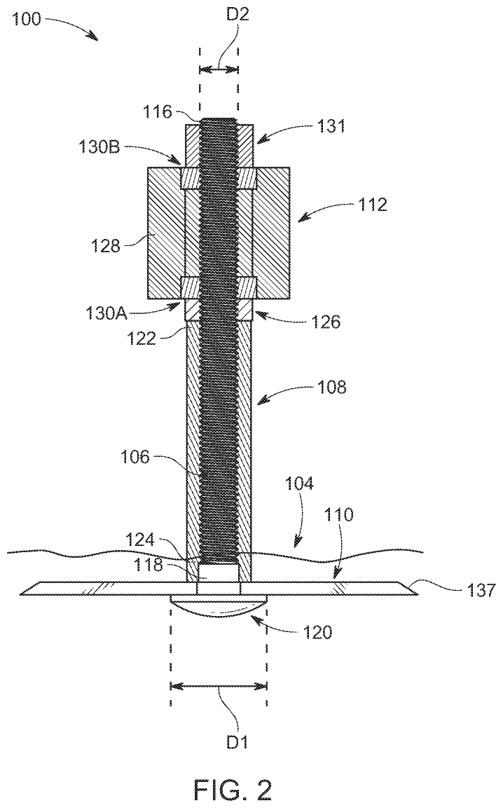

FIG. 2 is a cross-section view of an example plant removal device of the present disclosure. The device 100 includes a shaft 106, a sleeve 108, a material removal tool 110, and a mounting member 112.

In general, the shaft 106 can include a threaded rod having a first end 116 (also referred to as a terminal end) and a second end 118. The first end of the shaft can include a protrusion 120 having a diameter D1 that is slightly larger than a diameter D2 of the shaft 106. The protrusion 120 supports the material removal tool 110 when it is installed on the shaft 106 and acts as a stop to prevent the material removal tool 110 from disassociating with the shaft 106. While this particular configuration has been described, the shaft can also be configured to retain the material removal tool 110 while terminating with a flush or countersunk end.

In some embodiments, the material removal tool 110 is oriented orthogonally to the shaft 106, which ensures that a rotational axis R of the shaft 106 is substantially perpendicular to the soil 104. This type of orientation also has the added benefit of maintaining a low profile of the material removal tool 110 within the soil. That is tilting the material removal tool 110 may increase its cross-sectional area in the direction of travel, which may impede rotation.

In some embodiments, the sleeve 108 is a tubular extrusion that fits over the shaft 106. The sleeve 108 has a first end 122 and a second end 124. When the sleeve 108 is placed over the shaft 106, a portion of the shaft 106 extends from the second end 124 of the sleeve 108. The first end 122 of the sleeve 108 can abut or contact an upper surface of the material removal tool 110.

A first securement member 126 can be placed onto the shaft 106 above the second end 124 of the sleeve 106 so as to secure the sleeve 106 in place. The first securement member 126 can include a clamping nut or any other similar component. That is, the first securement member 126 can be threaded onto the shaft 106 until it contacts the second end 124 of the sleeve 106.

In embodiments where the shaft 106 is threaded, securement members used in combination with the shaft can be correspondingly threaded. When the shaft is not threaded, the securement members can be a compression fit or other securement to the shaft through welding or other similar attachment means.

The mounting member 112 can be placed above the first securement member 126 on the shaft 106. In some embodiments, the mounting member 112 has a body 128 that incorporates rotation elements such as bearings 130A and 130B. The bearings could include, for example, race bearings, but one of ordinary skill in the art will recognize other friction-reducing elements that assist rotation can also be used. The body 128, while illustrated as being cylindrical, can be shaped as desired. That is, the body 128 can have a shape that corresponds to a receiver of the driving implement. As noted above, the receiver can include a direct mount or armature of the driving implement.

A second securement member 131 can be placed above the mounting member 112 to secure the mounting member 112 in place on the shaft 106. Again, as with the first securement member 126, the second securement member 131 can include any suitable fastener that would be known to one of ordinary skill in the art.

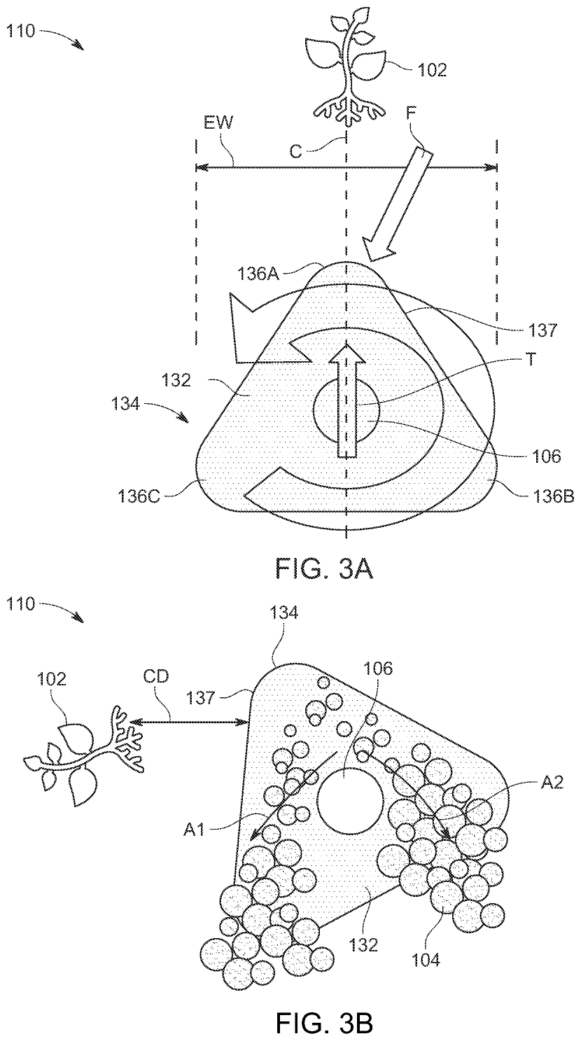

FIGS. 3A and 3B collectively provide a diagrammatic illustration of the material removal tool 110 in a state of translation and rotation. Of note, the material removal tool 110 has a body 132 with an outer-peripheral shape 134 that is in the form of a polygon. In this example, the body is shaped like a triangle. Vertices 136A-136C are each arcuate or rounded in shape. Radii of the vertices 136A-136C can be identical or different from one another. The exact dimensions of each vertex can be selected based on design parameters.

For example, one design parameter is that the material removal tool 110 has a consistent effective width W regardless of its orientation. While embodiments have been disclosed where vertices are arcuate, the present disclosure is not so limited, and other shapes for vertices of polygonal shapes can be used.

The orientation of the material removal tool 110 changes as the material removal tool 110 rotates, but the geometry of the outer-peripheral shape 134 can be chosen such that the effective width W is consistent or approximately consistent as the material removal tool 110 rotates while being moved relative to the soil. In general, the consistent effective width W is the portion of the outer-peripheral shape 134 of the material removal tool 110 that faces the direction of travel T. In the case of automated weeding applications (such as when the driving implement is autonomous), or even with fixed location implement tools, a clearance distance CD (FIG. 3B) for the device 100 required to a desired plant could be considered constant regardless of orientation. The clearance distance CD represents a distance between an edge of the material removal tool 110 to a desired plant (a plant that is not unwanted). The cutter ‘diameter’ can be considered effectively constant and therefore this dimension can be used to set the proximity to plants and maintain a safety distance between an edge of the material removal tool 110 and a desired plant.

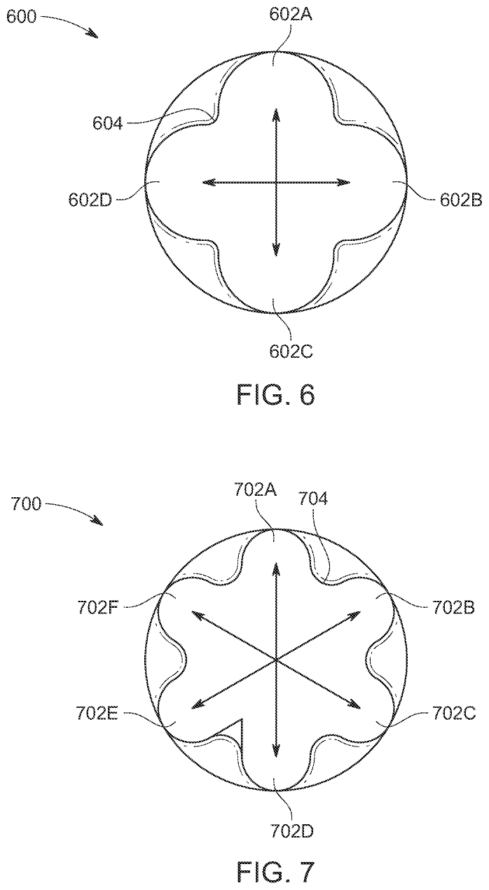

Another design parameter is that an outer-peripheral geometry or shape of the body 132 should be configured to encourage rotation of the material removal tool as it is moved relative to the soil. In some embodiments, the body 132 can be designed to maximize both a consistent effective width EW and optimal rotation. Additional example geometries for other material removal tools are illustrated in FIGS. 6 and 7.

Referring briefly to FIGS. 2-3B collectively, an edge 137 of the material removal tool 110 can be straight, beveled, chamfered, rounded, serrated, or otherwise profiled to enhance tilling of the soil and cutting/removal/dislodging of material from the soil. In some instances, only a portion of the outer peripheral edge of the body 132 has a profile. In other instances, all of the outer peripheral edge of the body 132 is profiled.

In FIG. 3A, the material removal tool 110 is translated in the direction of travel T. As the material removal tool 110 is translated, the shape of the material removal tool 110 causes rotation of the material removal tool 110 and the shaft 106 as the material removal tool 110 is moved through the soil 104. As the device is translated in the direction of travel and is rotating, the edge 137 of the material removal tool 110 contacts the unwanted material (e.g., weed 102), either cutting or pulling the unwanted material loose from the soil 104. In FIG. 3B, the unwanted material is discarded to the side or behind the material removal tool 110 while loose soil 104 deflects around the shaft 106 due to rotation of the material removal tool 110 and shaft 106. Small unwanted material may get caught up in the loose soil and move with the soil deflecting around the shaft.

Rotation of the material removal tool 110 and the shaft 106 causes material such as soil and weeds to divert around the shaft 106 and the material removal tool 110 rather than accumulating thereupon. The diversion of material around the shaft 106 and the material removal tool 110 are identified by arrows 136 and 138, which are provided for illustrative purposes only and are approximations of the direction of material travel around the shaft 106 and are not intended to be limiting.

Referring collectively to FIGS. 1-4, in operation, the device 100 is installed on the driving implement 10. The device 100 is mounted so as to be in contact with the soil 104. As noted above, device 100 couples to the driving implement 10 by way of the mounting member 112 of the device 100.

In some configurations, the material removal tool 110 is placed into the soil at a predetermined depth. As the device 100 is translated in a direction of travel by the driving implement, the soil contacts the material removal tool 110 inevitably creating an imbalance in forces causing the material removal tool 110 to rotate. Again, the shape of the material removal tool 110 aids in the rotation of the material removal tool 110 when an imbalance of force F develops to the right or left of the centerline C of the material removal tool 110. The consistent effective width W regardless of orientation allows for a smaller imbalance of force F to cause rotation.

As noted above, the force F is imparted to the material removal tool 110 as the material removal tool 110 is pushed or dragged through the soil 104. This force can be created by the soil or an object in the soil as it encounters the edge of the material removal tool 110. Thus, the force is a product of motion of the device 100 in the direction of travel T and contact by the material removal tool 110 of static material such as soil or plants and as such, may not be in the direction indicated.

It will be understood that the shaft 104, sleeve 106, and material removal tool 110 rotate as a single assembly. This assembly can freely rotate due to the presence of bearings inside the mounting member 112 that supports the shaft 104. It will be understood that while securement members such as nuts have been disclosed herein, other suitable fasteners can also be used. Further, the mechanisms used to attach the device to a driving implement can vary any configuration which allows combinations of the shaft 104, the sleeve 106, and the material removal tool 110 to freely rotate while being translated by a driving implement are contemplated. Examples herein are intended to be non-limiting unless specifically claimed.

The rotation of the mounting member 112 can cause the cutting or dislodging of material in the soil such as plant stems, roots, or other plant parts. The rotation of the shaft 104, sleeve 106, and material removal tool 110 also prevents or reduces a likelihood that material, such as soil or plant material accumulates on the device 100.

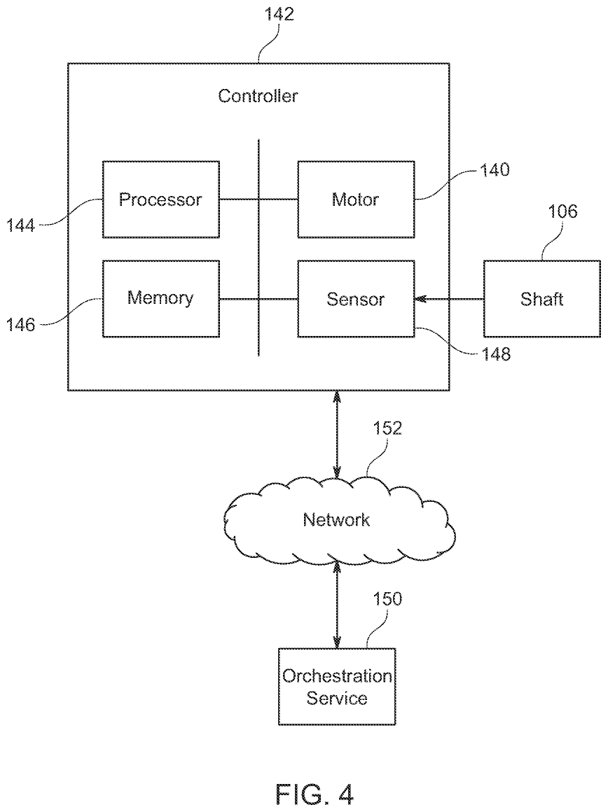

FIG. 4 is a schematic diagram of an architecture comprising a controller that can be used to control aspects of an example device. As noted above, the motor 140 can be configured to impart a rotational force to the shaft of the device 100. In some embodiments, the controller 142 can be used to automate the actuation of the motor 140. The controller 142 can comprise a processor 144 and memory 146 that stores instructions. The processor executes instructions stored in memory to control operations of the motor 140.

In some embodiments, the device 100 can include a sensor 148 that is configured to detect a rotation rate of the device 100. The motor may not be used when the movement of the implement is sufficient to rotate the device 100 at a threshold rotation rate. However, when soil conditions or implement speed are insufficient to allow the device to rotate at or above the threshold rotation rate. The controller 142 can be configured to detect when the implement is in motion but the rotation rate is below the threshold rotation rate. When this occurs, the controller 142 can activate the motor 140 to provide rotational force such that the device rotates at a speed that is at least the threshold rotation rate. The sensor 148 can also detect if the device 100 is stuck (e.g., no rotation) and cause the motor 140 to provide a reverse rotational force which may aid in freeing the device 100.

In some embodiments, the controller 142 can communicate with and receive instructions from an orchestration service 150, such as when the driving implement is an autonomous robot. The orchestration service 150 can control the deployment and operations of the autonomous robot through the controller 142. The controller 142 and the orchestration service 150 can bilaterally communicate over a network 152. The network 152 may include any one or a combination of multiple different types of networks, such as cable networks, the Internet, wireless networks, and other private and/or public networks. In some instances, the network 152 may include cellular, Wi-Fi, or Wi-Fi direct. Short-range wireless protocols can be used as well. Any suitable network may be used herein.

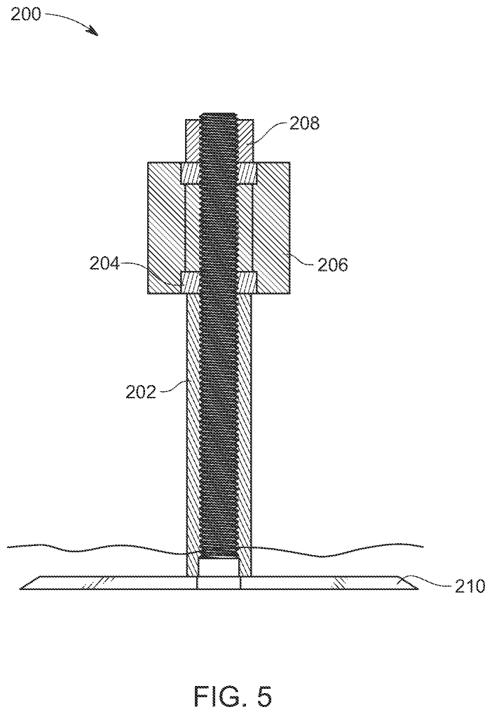

FIG. 5 is a cross-sectional view of another example plant removal device (hereinafter “device 200”) that is similar in construction to the device 100 of FIG. 1, with the following exceptions. The device 200 of FIG. 2, the first securement member (clamping nut) is omitted and the shaft 202 can mount proximately or in direct contact with bearings 204 of a mounting member 206. In this example, the shaft 202 can be tubular or solid, and the shaft 202 can have any desired length. The shaft 202 could be threaded or have a smooth outer surface.

An upper securement member 208 can be placed above the mounting member 206 to retain the mounting member 206 in place. The shaft 202 can be coupled with a material removal tool 210. That is, the material removal tool 210 is located at the terminal end of the shaft 202 which is opposite the upper securement member 208. In some embodiments, the material removal tool 210 is fixedly attached to the end of the shaft 202. In other embodiments, the material removal tool 210 can be removable by including a fastener, such as a nut, that can mate with the end of the shaft. Again, this mating can be threaded, compressive, or any other suitable means that would allow for releasable securement of the material removal tool 210 to the end of the shaft 202.

Again, the mounting member 206 is rotatably coupled to the shaft 202 with bearings or other similar components which allows the shaft 202 and the material removal tool 210 to freely rotate as a monolithic unit. The material removal tool 210 could be directly attached to the end of the shaft 202 using any known mechanism or method.

FIG. 6 is a top-down, plan view of another example material removal tool 600 that can be used in conjunction with any of the devices disclosed herein. The example material removal tool 600 has a generally polygonal shape with four vertices 602A-602D, which each has been rounded to promote rotation of the material removal tool 600. Transition areas between vertices, such as transition area 604 can be arcuate (e.g., concave) rather than angular to reduce a likelihood of an object getting trapped in an angular corner, which may prevent the material removal tool 600 from rotating. Stated generally, areas of the outer-peripheral geometry between adjacent vertices of the polygon can be concave.

FIG. 7 is a top-down, plan view of another example material removal tool 700 that can be used in conjunction with any of the devices disclosed herein. The example material removal tool 700 has a generally polygonal shape with six vertices 702A-702F, which each has been rounded to promote rotation of the material removal tool 700. Transition areas between vertices, such as transition area 704 can be arcuate (e.g., concave) rather than angular to reduce a likelihood of an object getting trapped in an angular corner, which may prevent the material removal tool 700 from rotating.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term may be occasionally interchangeably used with its non-hyphenated version, a capitalized entry may be interchangeably used with its non-capitalized version, a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “coupled,” “connected”, “connecting,” “mechanically connected,” etc., are used interchangeably herein to generally refer to the condition of being mechanically/physically connected. The terms “couple” and “coupling” are also used in a non-mechanical/physical context.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three-dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the technology to the particular forms set forth herein. To the contrary, the present descriptions are intended to cover such alternatives, modifications, and equivalents as may be included within the spirit and scope of the technology as defined by the appended claims and otherwise appreciated by one of ordinary skill in the art. Thus, the breadth and scope of a preferred embodiment should not be limited by any of the above-described exemplary embodiments.

Unless otherwise defined, all technical and scientific terms used herein have the same meaning as commonly understood by one of ordinary skill in the art to which this invention belongs. Although methods and materials similar to or equivalent to those described herein can be used in the practice or testing of the various embodiments of the present disclosure, suitable methods and materials are described above. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. The various embodiments of the present disclosure may be embodied in other specific forms without departing from the spirit or essential attributes thereof, and it is therefore desired that the various embodiments in the present disclosure be considered in all respects as illustrative and not restrictive. Any headings utilized within the description are for convenience only and have no legal or limiting effect.

What is claimed is:

1. A device, comprising:
a tubular sleeve;
a shaft extending through the tubular sleeve;
a material removal tool that is positioned between a terminal end of the shaft and an end of the tubular sleeve; and
a mounting member that is rotatably coupled to the shaft, the mounting member allowing the material removal tool and the shaft to freely rotate as the device is propelled in a direction of travel within soil, the material removal tool and the shaft freely rotate to prevent collection of material around the device.

2. The device according to claim 1, wherein the material removal tool is substantially flat and extends orthogonally to the shaft.

3. The device according to claim 1, further comprising a first securement member positioned above the tubular sleeve, the first securement member securing the tubular sleeve against the material removal tool.

4. The device according to claim 1, further comprising a second securement member positioned above the mounting member.

5. The device according to claim 1, further comprising a motor coupled with at least one of the tubular sleeve and the shaft, the motor imparting a rotation force to the tubular sleeve and/or the shaft.

6. The device according to claim 1, wherein the material removal tool has an outer-peripheral geometry that encourages rotation of the material removal tool as it is moved relative to the soil.

7. The device according to claim 6, wherein the outer-peripheral geometry has a consistent effective width regardless of orientation.

8. The device according to claim 6, wherein the outer-peripheral geometry is substantially triangular with each vertex having an arcuate shape.

9. The device according to claim 6, wherein the outer-peripheral geometry is substantially polygonal with each vertex having an arcuate shape.

10. The device according to claim 9, wherein areas of the outer-peripheral geometry between adjacent vertices are concave.

11. The device according to claim 6, wherein an outer edge of the material removal tool is at least one of serrated or beveled.

12. The device according to claim 6, further comprising bearings positioned between the mounting member and the tubular sleeve.

13. A device, comprising:
a shaft;
a material removal tool that is coupled to a terminal end of the shaft, the material removal tool having a polygonal shape with arcuate vertices that encourage rotation of the material removal tool when the material removal tool contacts material while being propelled in a direction of travel; and
a mounting member rotatably coupled to the shaft, the mounting member being configured to couple with a driving implement, wherein the material removal tool and the shaft freely rotate to prevent collection of material around the shaft or the material removal tool during use.

14. The device according to claim 13, wherein an outer edge of the material removal tool is at least one of serrated or beveled.

15. The device according to claim 13, further comprising bearings positioned between the mounting member and the shaft.

16. The device according to claim 13, wherein an outer-peripheral geometry of the material removal tool has a consistent effective width regardless of orientation.

17. The device according to claim 13, further comprising a motor coupled with the shaft, the motor imparting a rotation force to the shaft to rotate the material removal tool.

18. A device, comprising:
a sleeve having a first end and a second end;
a shaft extending at least partially through the sleeve, the shaft having a first end and a second end;
a material removal tool coupled to the first end of the shaft, the material removal tool being located between the first end of the shaft and the first end of the sleeve, the material removal tool having a serrated or beveled edge;
a first securement member coupled to the shaft and positioned above the second end of the sleeve;
a mounting member located above the first securement member, the mounting member being rotatably coupled to the shaft allowing the shaft and the material removal tool to freely rotate; and
a second securement member coupled to the shaft above the mounting member.

19. The device according to claim 18, further comprising a motor coupled with the shaft, the motor imparting a rotation force to the shaft to rotate the material removal tool.

20. The device according to claim 18, further comprising bearings positioned between the mounting member and the sleeve.
